(19) United States
(12) Patent Application Publication
(10) Pub. No.: US 2006/0082774 A1
(43) Pub. Date: Apr. 20, 2006

(54) Reference body for alignment of laser projectors and an image data acquisition system, and tomography apparatus including same

(76) Inventors: Thorsten Buttner, Kirchehrenbach (DE); Winfried Korber, Hallerndorf (DE); Carsten Thierfelder, Frankfurt (DE)

Correspondence Address: SCHIFF HARDIN, LLP;PATENT DEPARTMENT, 6600 SEARS TOWER, CHICAGO, IL, 60606-6473, US

(21) Appl. No.: 11/243,230

(22) Filed: Oct. 4, 2005

(30) Foreign Application Priority Data
Oct. 4, 2004 (DE) 10 2004 048 643.3

(51) Int. Cl. G01B 11/00

(52) U.S. Cl. 356/399

(57) ABSTRACT

A reference body for alignment of laser projectors and an acquisition system of a tomography apparatus relative to one another, has at least two reference indicators, with each reference indicator establishing a reference plane. Each reference plane serves for alignment of one of the laser projectors. The at least two reference indicators enable the simultaneous alignment of laser projectors without a shifting of the reference body being necessary. A computed tomography apparatus includes such a reference body

### BACKGROUND OF THE INVENTION

1. Field of the Invention

The present invention concerns a reference body for alignment of laser projectors and an image data acquisition system relative to one another. The invention also concerns a tomography apparatus with such a reference body.

2. Description of the Prior Art

Tomography apparatuses, in particular computed tomography apparatuses, are equipped with special internal laser projectors that serve for visualization of the position of the measurement field plane and the measurement field center of the computed tomography apparatus, or for marking a subject region on the surface of a subject. Additionally, external laser projectors (for example robot arm-controlled) are used for marking the subject region. Such marking aids serve for precisely planning an examination region from which, for example, raw data relevant for a diagnosis should be acquired by the acquisition system of the computed tomography apparatus.

A precise acquisition of the relevant raw image data from the examination region indicated by the laser projectors is ensured only when the laser projectors and the acquisition system, or the measurement field plane associated with the acquisition system, are aligned precisely relative to one another.

A reference body for alignment of the laser projectors relative to the acquisition system, or relative to the measurement field plane, is known from DE 195 32 522 A1. The reference body has the shape of a narrow cuboid with a slight expansion. The reference body is initially positioned in a marking plane for setting the alignment. A circumferential groove on the reference body that is irradiated by a laser serves as a reference for precise positioning of the reference body in the marking plane. A point on the reference body at which the circumferential groove intersects an additional groove serves as a reference for alignment of further laser projectors. Adjustments of the laser projectors with regard to such a reference are, however, not precisely detectable, such that an exact alignment of a number of laser projectors relative to the measurement field plane is not possible without adjustment of the reference body.

### SUMMARY OF THE INVENTION

An object of the present invention is to provide a reference body suitable for the above-described purpose that allows a precise but simple alignment of a number of laser projectors and an acquisition system of a tomography apparatus relative to one another, without adjustment of the reference body.

This object is achieved in accordance with the invention by having at least two reference indicators, each reference indicator defining a reference plane, and wherein each reference indicator is disposed on the reference body for alignment of one of the laser projectors.

The above object also is achieved by a tomography apparatus incorporating such a reference body.

According to the invention, the at least two laser projectors and the acquisition system can be aligned relative to one another in a simple manner without adjustment of the reference body. This is possible because the inventive reference body has at least two reference indicators, with a reference plane being established by each reference indicator, relative to which reference plane the respective laser projector can be exactly aligned.

Laser projectors that are used for display of the measurement field plane or the measurement field center or for marking of subject regions typically generate a projection in the form of a laser fan. Even slight deviations, in particular given opposite tilting of the reference indicators relative to the laser projector on one of the coordinate axes of the tomography apparatus, are easily detectable by an offset (shift) of the projection of the laser projector relative to the reference plane and this are correctable. References without a sufficiently flat expansion (as is the case, for example, given the use of a reference point or two different reference points) do not ensure this since not all degrees of freedom of adjustment of the laser projector are detected.

A particularly simple shape of the reference body, that can thus be produced with less effort, is achieved when the reference body has three surfaces arranged orthogonal to one another. This is the case, for example, for a reference body in the form of a cuboid.

The reference indicators preferably are formed by at least one groove and, for example, can be machined milled into the surface of the reference body in a simple manner. Each reference indicator can be formed, for example, by a single groove circulating around the circumference of the reference body. Alternatively, multiple separate grooves that together span one of the reference planes can form a reference indicator.

In an embodiment of the invention, at least one of the reference planes runs parallel to a generated surface of the reference body so that operating personnel can easily identify the orientation of the reference planes from the orientation of the generated surface.

At least one of the reference planes preferably divides the reference body into two sub-regions of equal size. A fast and intuitive positioning of the reference body in the measurement field plane at the beginning of an alignment procedure is possible with such an arrangement of the reference plane. Placement of the reference planes so that the reference body is divided into two sub-regions of different sizes is advantageous when a number of neighboring reference planes for the reference body are provided simultaneously. Moreover, in a further embodiment of the invention the reference planes are orthogonal to one another so that laser projectors that are orthogonal to one another can be aligned relative to the acquisition plane without adjustment of the reference body.

The reference body has an adjustment device for adjustment relative to a support device. The reference body thus can be adjusted in a simple manner (particularly in terms of its inclination) relative to the acquisition system without the support device itself (for example the table plate of a computed tomography apparatus) having to be changed in terms of inclination.

A simple and simultaneously safe monitoring of the alignment of the reference body is advantageously ensured when the reference body has at least one bubble level.

The reference body can be manufactured easily and with little effort given the use of a synthetic solid transparent resinous material such as Plexiglass®. Moreover, the reference indicators for example in the form of grooves) can be easily machined in a simple manner given the use of such a material.

### DESCRIPTION OF THE DRAWINGS

FIG. 1 schematically illustrates an inventive tomography apparatus with an inventive reference body.

FIG. 2 is a perspective view showing the inventive cuboidal reference body of FIG. 1 in a detail view.

FIG. 3 is a perspective view of a second inventive reference body with three orthogonal surfaces, with the intersection of the surfaces coinciding with the center of the surfaces.

FIG. 4 is a perspective view of a third inventive reference body with three orthogonal surfaces, with the intersection of the surfaces lies at a vertex of the surfaces.

### DESCRIPTION OF THE PREFERRED EMBODIMENTS

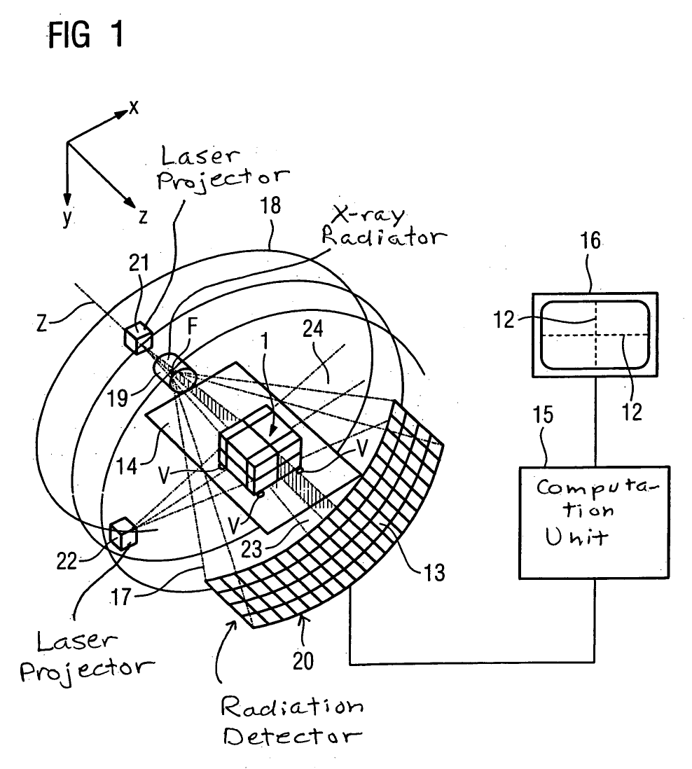

An inventive tomography apparatus, in this case a computed tomography apparatus, is shown in FIG. 1 in representation that is partially perspective and partially like a block diagram. The computed tomography apparatus has an acquisition system with an x-ray radiator 19 and a radiation detector 20 (formed by detector elements 13 in columns and rows in a detector element array), laser projectors 21, 22, a reference body 1, a computation unit 15 for reconstruction of slice or volume images, and a display unit 16.

The x-ray radiator 19 and the radiation detector 20 are mounted opposite one another on a rotary frame (not shown) such that, in the operation of the computed tomography apparatus, an x-ray beam emanating from a focus F of the x-ray radiator 19 and bordered by edge rays 17 strikes the detector 20. Scanning of an acquisition region can be implemented in the form of a spiral scan 18 given rotation of the rotary frame and simultaneous continuous feed of the patient table 14 in the direction of a system axis Z of the computed tomography apparatus.

The laser projectors 21, 22 are permanently connected with a housing (not shown) of the computed tomography apparatus and each generates a laser beam (for example in the form of laser fans 23 and 24) to indicate the measurement field plane and the center of the measurement field plane. A computed tomography apparatus typically has four different laser projectors that radiate parallel to the following planes of a Cartesian coordinate system shown in FIG. 1: a first laser projector radiates parallel to the y-z plane; a second laser projector and a third laser projector radiate parallel to the x-z plane; and a fourth laser projector radiates parallel to the y-z plane. For clarity, only two of the four laser projectors are shown in FIG. 1, namely the first laser projector 21 radiating in the y-z plane and the second laser projector 22 radiating in the x-z plane.

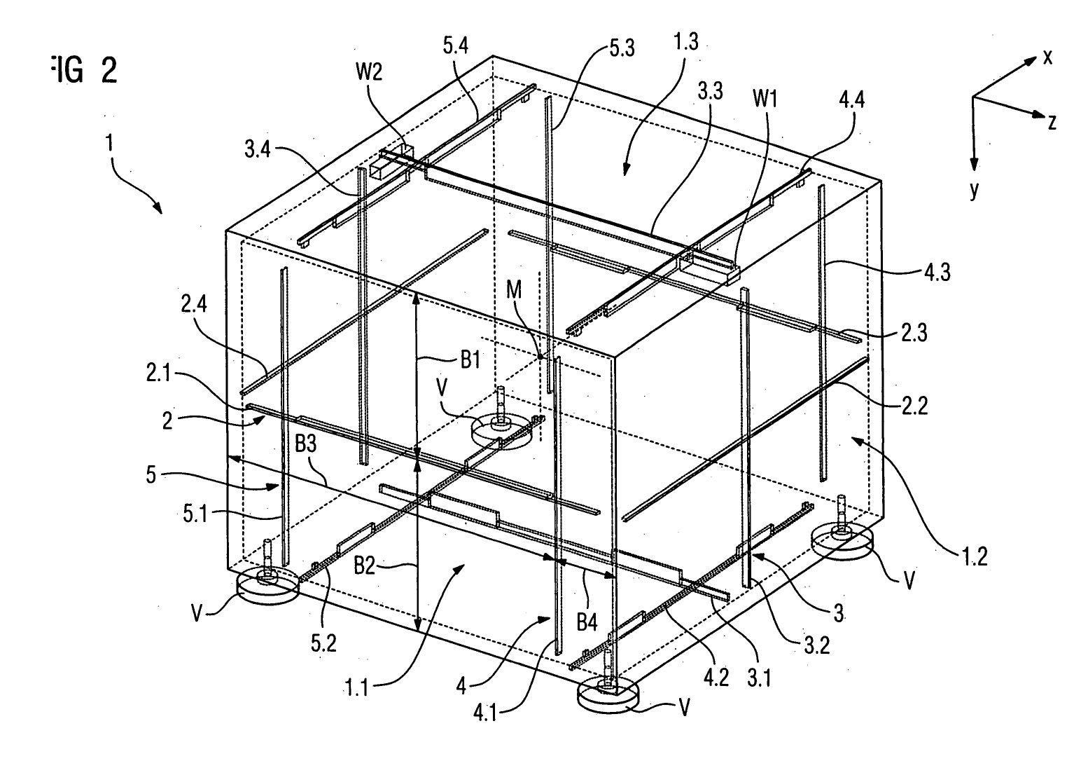

The reference body 1 shown in FIG. 1 has a cuboid form and in total has the first four reference indicators 2, 3, 4, 5 shown in FIG. 2. Each reference indicator 2 or 3 or 4 or 5 establishes a reference plane. The reference indicators 2, 3, 4, 5 enable the simultaneous alignment of all laser projectors 21, 22 relative to the acquisition system 19, 20 without the reference body 1 having to be adjusted in terms of position. The reference body 1 is supported on a support device, here in the form of the patient table 14. An adjustment device V associated with the reference body 1 enables adjustment of the position of the reference body 1, and thus of the reference indicators 2, 3, 4, 5 relative to the support device 14 or relative to the acquisition system 19, 20.

Alignment of the laser projectors 21, 22 and of the acquisition system 19, 20 relative to one another essentially involves the following steps:
a) positioning of the reference body 1 in the measurement region of the computed tomography apparatus,
b) acquisition of a slice or projection image of the reference body 1 and display of the image on the display unit 16,
c) testing and determination of the deviation between the mapped reference indicators 2 or 3 or 4 or 5 and a device coordinate system 12 corresponding thereto,
d) adjustment of the adjustment device V or of the support device 14 by the amount of the deviation,
e) repetition of steps b through d until the reference indicators 2, 3, 4, 5 essentially come into congruence with the device coordinate system 12,
f) positioning of the laser projectors 21, 22 so that the projected laser fans 23, 24 come into congruence with the corresponding reference planes or with the corresponding reference indicators 2, 3, 4, 5.

In the event that it is necessary, the reference indicators 2, 3, 4, 5 can embody an x-ray-positive material so that a high-contrast imaging of the reference indicators is ensured in a slice image.

A detailed view of the reference body 1 from FIG. 1 is shown in FIG. 2. The reference body 1 is shown in perspective and has the shape of a cuboid that is aligned relative to a shown Cartesian coordinate system. The edge lengths of the cuboid exemplarily, respectively amount to 40 cm in the shown x-direction and y-directions and 30 cm in the z-direction.

As already mentioned, overall the reference body has four reference indicators 2, 3, 4, 5, with a reference plane being established by each of the reference indicators 2 or 3 or 4 or 5. Each reference indicator 2, 3, 4, 5 is formed by four grooves 2.1, 2.2, 2.3, 2.4 or 3.1, 3.2, 3.3, 3.4 or 4.1, 4.2, 4.3, 4.4 or 5.1, 5.2, 5.3, 5.4 that are distributed around the circumference of the reference body 1. The grooves 2.1, 2.2, 2.3, 2.4 and 3.1, 3.2, 3.3, 3.4 and 4.1, 4.2, 4.3, 4.4 and respectively, 5.1, 5.2, 5.3, 5.4 can be applied to the surface of the reference body 1 by milling, for example. In the shown example, the grooves 2.1, 2.2, 2.3, 2.4 and 3.1, 3.2, 3.3, 3.4 and 4.1, 4.2, 4.3, 4.4 and 5.1, 5.2, 5.3, 5.4 are dimensioned to 2.5 mm in width and 3 mm in depth. Opposite grooves 2.1, 2.3 and 2.2, 2.4, or 3.1, 3.3 and 3.2, 3.4, or 4.1, 4.3 and 4.2, 4.4 or 5.1, 5.3 and 5.2, 5.4 can also exhibit small bores (not shown) so that an undisturbed irradiation of the laser beam of the respective laser projector through the reference body 1 is ensured. A first reference plane parallel to the x-z plane is established by the first reference indicator 2. The first reference plane divides the reference body 1 into two equally-large sub-regions B1, B2. This also applies for the second reference indicator 3 in an orthogonal direction. Third and fourth reference planes which run parallel to the x-y plane are respectively established by the third and fourth reference indicators 4, 5. The third reference plane respectively divides the reference body 1 into sub-regions B3, B4 of different sizes. This corresponding applies for the fourth reference plane. The third and the fourth reference means are moreover arranged symmetrical with the center point M of the reference body 1.

The reference body 1 enables the simultaneous exact alignment of all laser projectors 21, 22 relative to the acquisition system 19, 20, in that all reference planes necessary for alignment are established by the reference means 2, 3, 4, 5.

The four set of grooves 2.1, 2.2, 2.3, 2.4 and 3.1, 3.2, 3.3, 3.4 and 4.1, 4.2, 4.3, 4.4 and 5.1, 5.2, 5.3, 5.4 respectively forming reference planes are a simple configuration for checking the exact alignment of the respective laser projectors 21 and 22. Even given slight tilting or given slight shifting of the laser projector 21 or 22 relative to the reference plane, the laser fan 23 or 24 exhibit a visible offset relative to the grooves 2.1, 2.2, 2.3, 2.4 or 3.1, 3.2, 3.3, 3.4. Other reference indicators are conceivable, for example in the form of bores or adhered target markers. Other reference means are also conceivable that have an x-ray-positive material in the form of a metallic sphere or a cross. It is important that only one reference plane is unambiguously established in terms of position by the each reference indicator.

The reference body 1 has an adjustment device V in the form of four feet below the cuboid that can be adjusted in terms of height. The reference body 1 can be corrected in a simple manner in terms of its position relative to the bearing device 14 or relative to the acquisition system 19, 20. Two bubble levels W1, W2 that serve for monitoring the position of the reference body 1 are additionally provided on the upper surface parallel to the x-z plane so that the reference body 1 can be aligned exactly horizontally.

In this exemplary embodiment, the reference body 1 composed of Plexiglass® that is permeable relative to laser radiation. Plexiglass® can be easily processed so that the grooves 2.1, 2.2, 2.3, 2.4 and 3.1, 3.2, 3.3, 3.4 and 4.1, 4.2, 4.3, 4.4 and 5.1, 5.2, 5.3, 5.4 can be produced with less effort by milling. Other materials (for example plastic-based) can also be used.

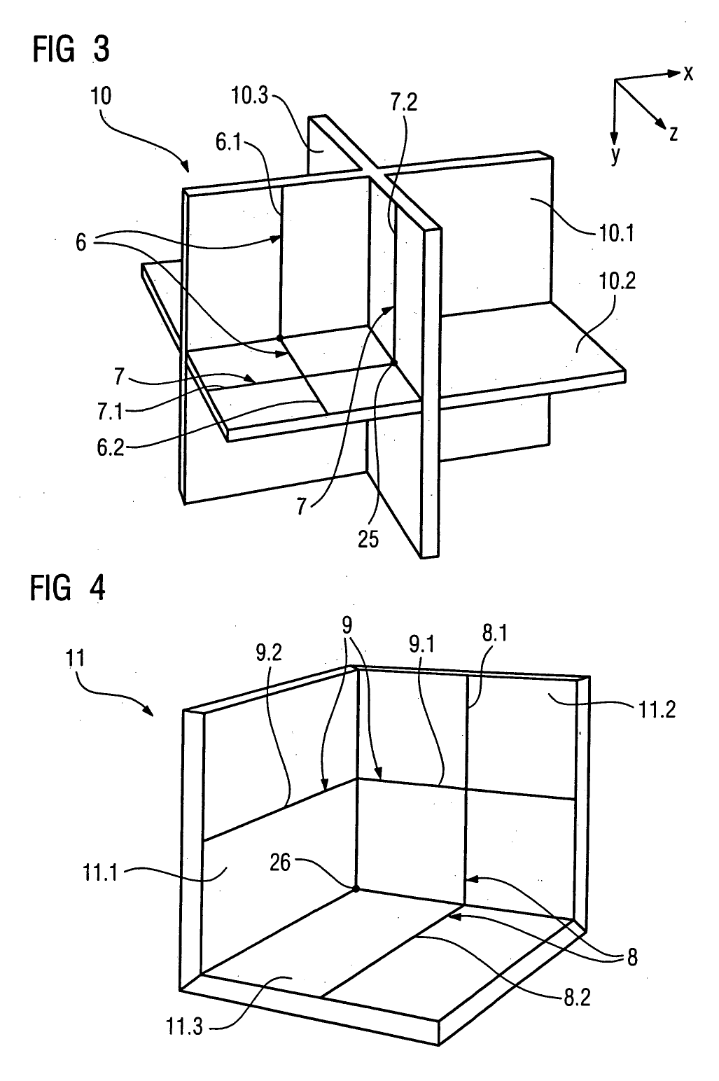

FIGS. 3 and 4 show further exemplary embodiments of an inventive second and third reference body 10, 11 in a perspective representation. The shown reference bodies are each formed from three surfaces 10.1, 10.2, 10.3, 1.1, 11.2, 11.3 that are orthogonal to one another.

In FIG. 3 the surfaces 10.1, 10.2, 10.3 of the second reference body 10 are arranged relative to one another such that an intersection point 25 of the surfaces 10.1, 10.2, 10.3 of the second reference body 10 coincides with the respective center points of the surfaces 10.1, 10.2, 10.3. The second reference body 10 exemplarily has two reference indicators 6, 7 that are respectively formed by two grooves 6.1, 6.2, and 7.1, 7.2. The reference planes defined by the reference indicators 6, 7 are perpendicular to one another. Such a second reference body 10 would still additionally have further reference indicators (not shown). In FIG. 4 the surfaces 11.1, 11.2, 11.3 of the third reference body 11 are arranged relative to one another such that an intersection point 26 of the surfaces 11.1, 11.2, 11.3 of the third reference body 11 coincide with respective vertices of the surfaces 11.1, 11.2, 11.3. The third reference body 11 also exemplarily has two reference indicators 8, 9 respectively formed by two grooves 8.1, 8.2, and 9.1, 9.2. However, the reference body 11 can also exhibit a different three-dimensional shape, for example in the form of a pyramid.

Such a reference body 1 is suited not only for alignment of the laser projectors, but rather also for checking a shift (movement) direction of the support device 14 shown in FIG. 1 relative to the system axis Z of the tomography apparatus. For this purpose, the reference body is scanned by means of a spiral scan, thus given rotation of the acquisition system and given simultaneous shift of the reference body via the bearing device. Two slice images are subsequently reconstructed by the computation unit 15 and shown at the display unit 16, the slice images lying in both reference planes of the third and fourth reference indicators 4, 5. The positions of the respective grooves 2.1, 2.3 and 3.1, 3.3 imaged in the slice images serve for testing of a parallelism of the shift of the support device 14 relative to the system axis Z of the computed tomography apparatus.

Although modifications and changes may be suggested by those skilled in the art, it is the intention of the inventors to embody within the patent warranted hereon all changes and modifications as reasonably and properly come within the scope of their contribution to the art.

We claim as our invention:

1. A reference body for alignment of at least two laser projectors and an image data acquisition system of a tomography apparatus relative to each other, said reference body comprising:
a reference body structure; and
for each laser projector, at least two reference indicators on said reference body structure, each of said reference indicators establishing a reference plane for one of said laser projectors, said at least two reference indicators enabling simultaneous alignment of at least two laser projectors without physically shifting said reference body structure.

2. A reference body as claimed in claim 1 wherein said reference body structure comprises three surfaces disposed orthogonally relative to each other.

3. A reference body as claimed in claim 1 wherein said reference body structure has a cuboid shape.

4. A reference body as claimed in claim 1 wherein each of said at least two reference indicators comprises at least one groove in said reference body structure.

5. A reference body as claimed in claim 1 wherein said reference body structure has an exterior surface, and wherein at least one of said planes established by at least one of said two reference indicators is parallel to said exterior surface.

6. A reference body as claimed in claim 1 wherein at least one of said reference planes established by at least one of said reference indicators divides said reference body structure into two sub-regions of equal size.

7. A reference body as claimed in claim 1 wherein at least one of said reference planes established by at least one of said reference indicators divides said reference body structure into two sub-regions of different sizes.

8. A reference body as claimed in claim 1 wherein the respective reference planes established by said reference indicators are disposed orthogonally relative to each other.

9. A reference body as claimed in claim 1 comprising an adjustment device allowing adjustment of said reference body relative to a support device adapted to support said reference body.

10. A reference body as claimed in claim 1 comprising at least one bubble level disposed in said reference structure for horizontally aligning said reference body structure.

11. A reference body as claimed in claim 1 wherein said reference body structure is comprised of a solid transparent resinous material.

12. A tomography apparatus comprising:
an image data acquisition system;
at least two laser projectors; and
a reference body for aligning said at least two laser projectors and said image data acquisition system relative to each other, said reference body comprising a reference body structure, and for each laser projector, at least two reference indicators on said reference body structure, each of said reference indicators establishing a reference plane for one of said laser projectors, said at least two reference indicators enabling simultaneous alignment of at least two laser projectors without physically shifting said reference body structure.

13. A tomography apparatus as claimed in claim 1 comprising a patient table adapted to receive a patient thereon, said patient table being movable relative to said at least two laser projectors and said image data acquisition system, and an adjustment device attached to said reference body structure and resting on said patient table, allowing physical adjustment of said reference body structure relative to said patient table.
